(19) United States
(12) Patent Application Publication
(10) Pub. No.: US 2018/0075420 A1
(43) Pub. Date: Mar. 15, 2018

(54) SYSTEMS AND METHODS FOR INTEGRATING HEALTHY LIVING PROGRAMS WITH PAYMENT NETWORKS

(71) Applicant: American Express Travel Related Services Company, Inc., New York, NY (US)

(72) Inventors: Lee Barnett, Phoenix, AZ (US); Krista Freiland, Phoenix, AZ (US); Satish Jayaraman, Phoenix, AZ (US); Manish Joon, Phoenix, AZ (US); Jeff Nunn, Phoenix, AZ (US)

(73) Assignee: American Express Travel Related Services Company, Inc., New York, NY (US)

(21) Appl. No.: 15/266,633

(22) Filed: Sep. 15, 2016

(51) Int. Cl. G06Q 20/10; G06Q 30/02

(52) U.S. Cl. CPC G06Q 20/102; G06Q 30/0207

(57) ABSTRACT

A computer-based system may register a fitness device with a transaction account by associating a device identifier of the fitness device with the transaction account in a database. The system may detect a health-related activity such as, for example, measurements from the fitness device, social media posts, or user recommendations. The system may thus issue rewards, such as rewards points, in response to detecting the health-related activity.

### FIELD

This disclosure relates to systems and methods for integrating healthy living programs with a payment network.

### BACKGROUND

Consumers in general are growing increasingly concerned with healthy living. In that regard, many consumers make eating decisions based on health consequences. Consumers also make activity decisions based on exercise value that impacts health. The health-conscious consumers of the world are often looking to be the healthiest they can be. Sometimes, though, they fail.

To help with being health conscious, consumers can install an application to track eating. Consumers can install another application to track exercise. A wearable device can track daily steps, heartrate, or other fitness information. There are many tools to track healthy living, but not many motivational tools. Motivation and discipline are often difficult to maintain for those trying to adhere to a strict dietary plan or exercise regimen.

Furthermore, tools for healthy living have become increasingly available, but there is often limited integration between the various tools. Fitness devices may have limited integration to payment networks, if any. For example, a fitness wearable that may have a digital wallet for use at a point of sale typically would not otherwise integrate into a payment network.

### SUMMARY

A system, method, and computer readable medium (collectively, the “system”) is disclosed for integrating health-related offers and rewards with health-related activities, locations, and engagements into purchases. The system may register a fitness device with a transaction account by associating a device identifier of the fitness device with the transaction account in a database record. The system may detect a health-related activity such as, for example, measurements from the fitness device, social media posts, or user recommendations. The system may issue rewards (e.g., rewards points) in response to detecting the health-related activity.

In various embodiments, the system may register a health-related location by storing a geographic area or a health-related merchant device identifier in a database. The system may detect the fitness device at the health-related location and issue a reward in response. The system may also store an offer in association with the geographic area or the health-related merchant device identifier. Thus, in response to detecting the fitness device at the health-related location, the system may identify the offer and transmit the offer to the fitness device. The system may further be configured to detect health-related purchases and issue reward in response to the purchases. The system may similarly detect a health-related engagement and issue a reward in response to the health-related engagement.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

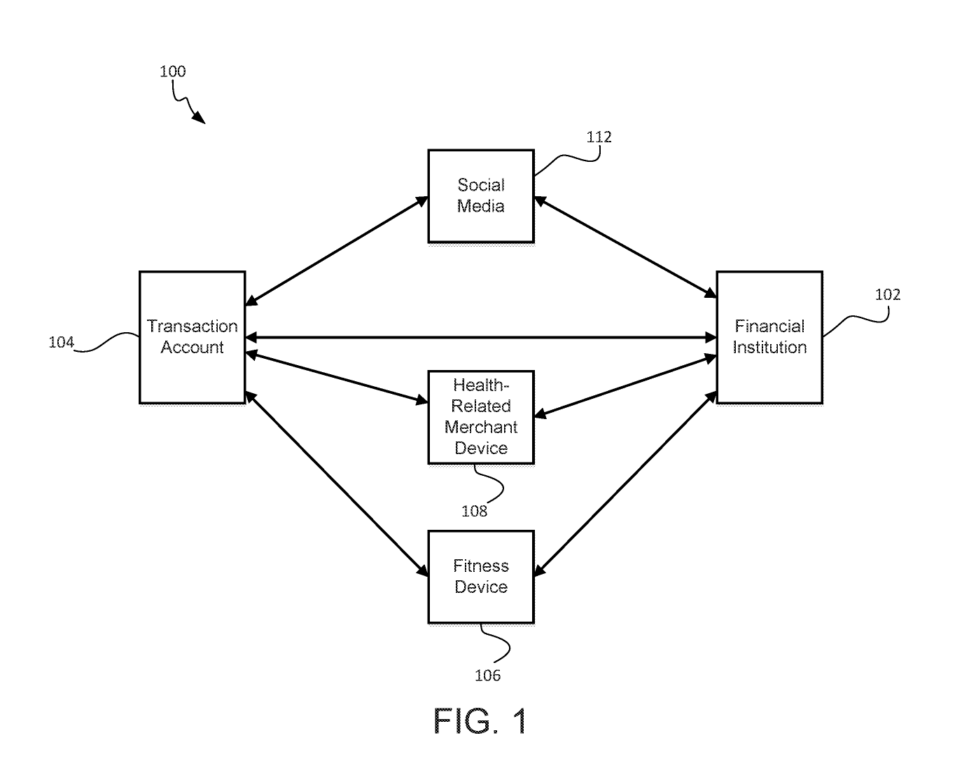

FIG. 1 illustrates an exemplary system for integrating fitness devices, user locations, fitness merchants, and social media with transaction accounts, in accordance with various embodiments;

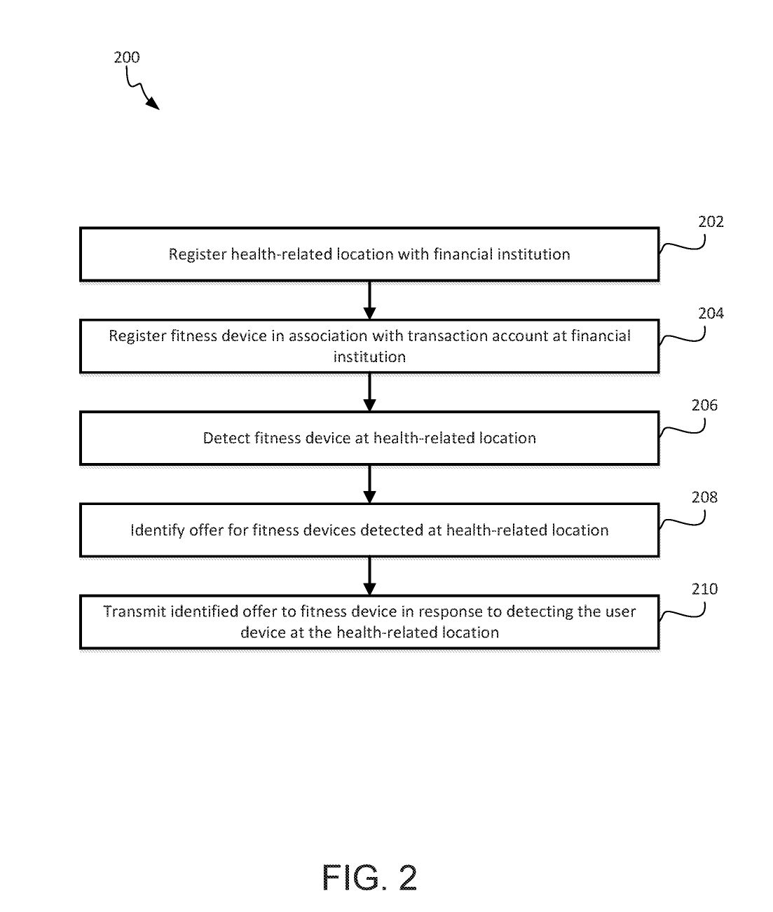

FIG. 2 illustrates an exemplary process for offering location-based offers in response to detecting a user at a health-related location, in accordance with various embodiments;

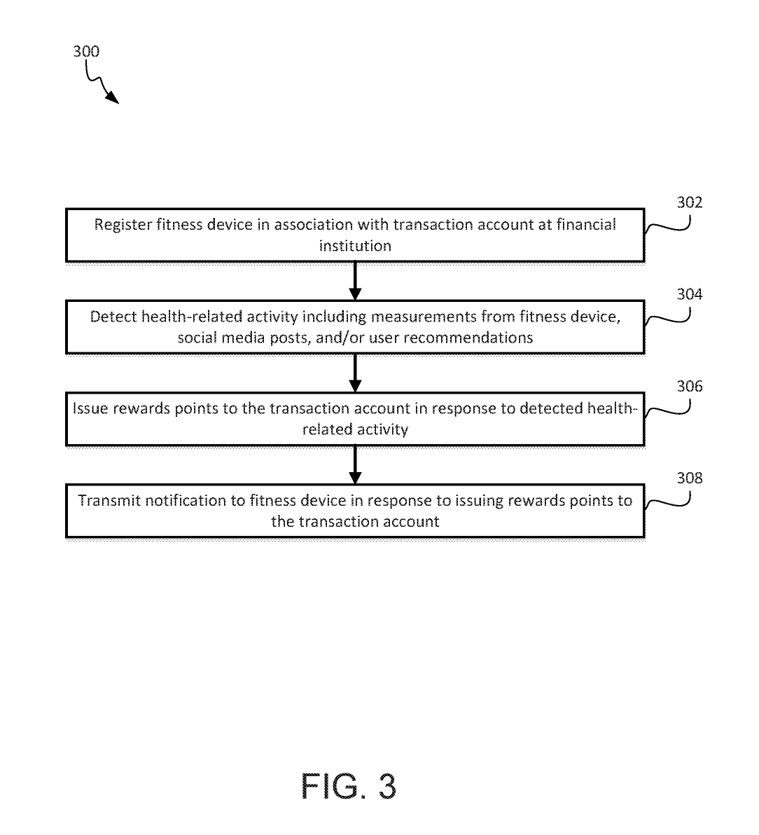

FIG. 3 illustrates an exemplary process for issuing rewards in response to detecting health-related user activity, in accordance with various embodiments;

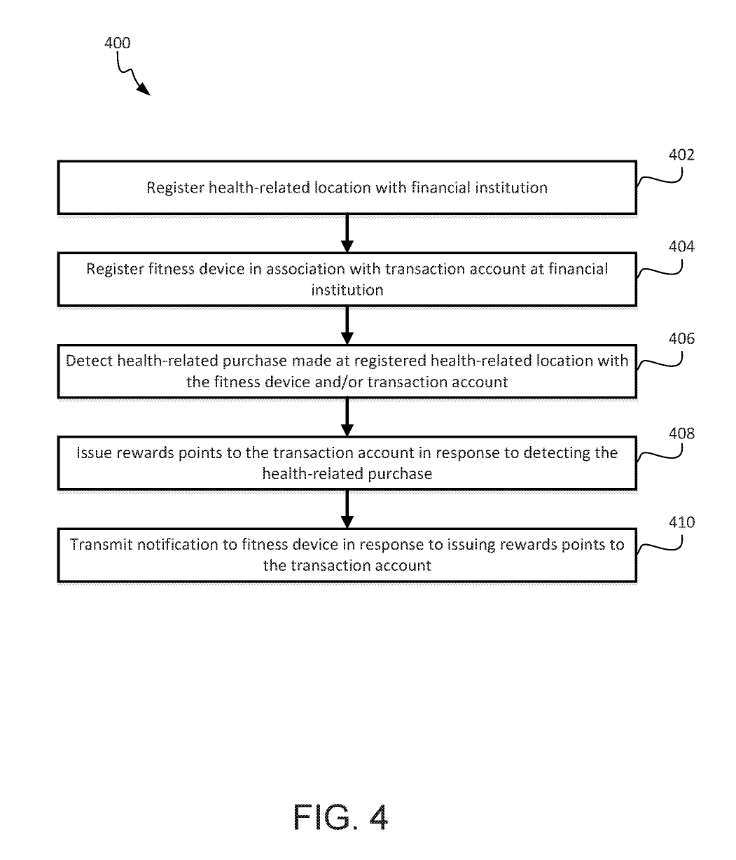

FIG. 4 illustrates an exemplary process for issuing rewards in response to detecting user purchases at health-related merchants, in accordance with various embodiments; and

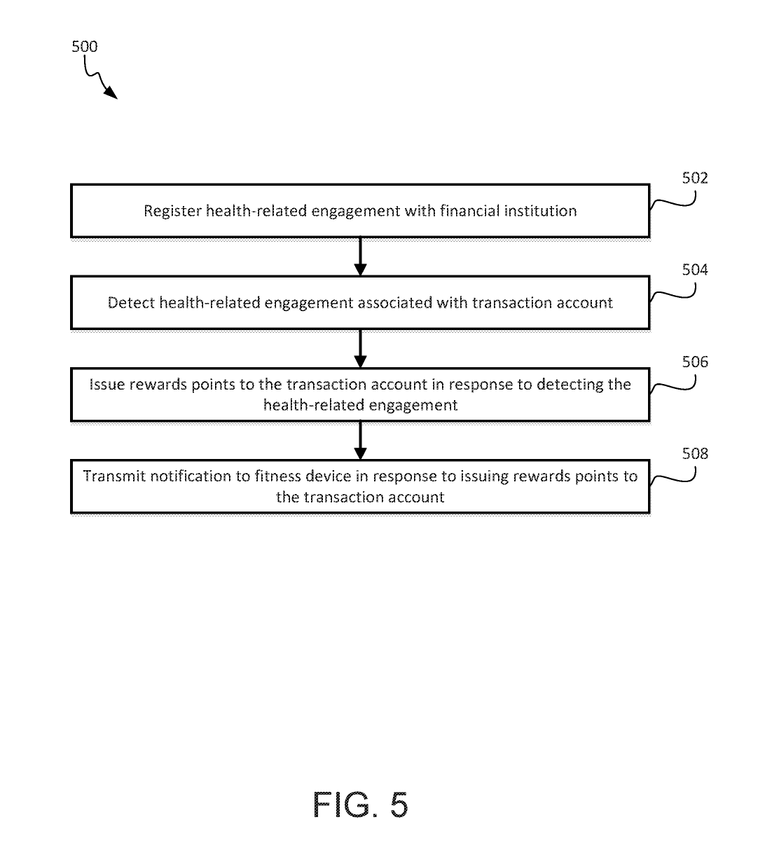

FIG. 5 illustrates an exemplary process for issuing rewards in response to detecting user enrollment and/or participation in health-related activities, in accordance with various embodiments.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description is presented for purposes of illustration only and not of limitation. For example, the steps recited in any of the method or process descriptions may execute in any order and are not limited to the order presented. Moreover, any of the functions or steps may be outsourced to or performed by one or more third parties. Furthermore, any reference to singular includes plural embodiments, and any reference to more than one component may include a singular embodiment.

A transaction account may interact with health-related locations, health-related devices, health-related content, health-related data and/or health-related activities to provide transaction account holders (i.e., users) with an integrated healthy living experience. The transaction account may be registered in association with health devices (e.g., FitBit®, iWatch®, Jawbone®, or other fitness-related devices) to provide an integrated benefit, promotion, and offer system. The system may be responsive to users purchasing healthy foods, purchasing exercise products, enrolling in fitness classes, joining gyms, playing in sports leagues, running marathons, training, medical services or other health-related activities. The transaction account may benefit from enhanced financing terms for similar health-related activities, goods, and/or services. Users may transfer health-related rewards to motivate friends and family members enrolled in the health-based system. Location detection technology may be integrated with health-based devices to enable location-based offers for health-related activities, goods, and/or services.

As used herein, phrases similar to “health-related” or “health-based” activities, data, content, goods and services are those relating to a healthy, changed and/or improved lifestyle. For example, health-related activities include playing sports, joining a gym, running a race, riding a bicycle, and/or visiting a doctor. In another example, health-related goods may include running shoes, sporting goods, fitness devices, fitness periodical subscriptions, healthy food choices, and/or exercise machines. Exemplary health-related services further include gym memberships, sports league dues, medical services, dietary planning, personal training, and/or fitness tracking applications.

With reference to FIG. 1, system 100 is shown for integrating transaction accounts with health-based activities, goods, and services, in accordance with various embodiments. System 100 may include a financial institution connected to system 100 via financial institution server 102. Financial institution server 102 may include one or more computing devices to provide transaction accounts and communicate with other devices described herein. Financial institution servers 102 may communicate electronically with fitness devices 106, health-related merchant device 108, and/or social media servers 112 over a network including, for example, a WAN, a LAN, and/or the Internet.

In various embodiments, fitness device 106, health-related merchant device 108, social media servers 112, and/or financial institution servers 102 may comprise computing devices. The computing devices may take the form of a computer or processor, or a set of computers/processors, although other types of computing units or systems may be used. Exemplary computing devices include servers, pooled servers, laptops, notebooks, hand held computers, personal digital assistants, cellular phones, smart phones (e.g., iPhone®, Android®, etc.) tablets, wearables (e.g., smart watches and smart glasses), Internet of things (IOT) devices or any other device capable of receiving data over network.

Fitness device 106 may further include a wearable fitness tracking device such as, for example, FitBit®, iWatch®, Jawbone®, or other health-related wearable devices. The wearable may be registered or paired with another user device such as a computer or smartphone or may operate independently of paired devices. Health-related merchant device 108 may further include electronic devices configured to detect a fitness device 106. The detection may be wireless and/or within a predetermined range. For example, health-related merchant device 108 may include a Bluetooth® low-energy (BLE) beacon or other BLE enabled device that detects and/or broadcasts a Bluetooth® signal from/to fitness device 106. Each computing device may run applications to interact and communicate with other devices and otherwise operate within system 100.

The above computing devices may communicate via a network. As used herein, the term “network” includes any cloud, cloud computing system or electronic communications system or method that incorporates hardware and/or software components. Communication among the parties may be accomplished through any suitable communication channels. Exemplary communication channels include a telephone network, an extranet, an intranet, Internet, point of interaction device (point of sale device, personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

In various embodiments, financial institution servers 102 may maintain ledgers and provide account access to transaction accounts 104. Transaction account 104 may be registered with financial institution servers 102, fitness device 106, or other payment media (e.g., a credit card or digital wallet) to complete purchase transactions. Fitness device registration is described in greater detail below. Transaction account 104 may be configured to complete transactions using fiat currency or rewards points. Rewards points may be earned based on detectable health-based activities of a user in association with fitness device 106, health-related merchant device 108, and/or social media severs 112, for example.

A user may complete transactions with health-related merchant device 108 and/or social media servers 112 using transaction account 104 maintained on financial institution servers 102. A user may also link social media accounts maintained on social media servers 112 with their transaction account 104 maintained on financial institution servers 102 to enable financial institution servers 102 to make offers and issue rewards based on health-related social media activity. Further information and features related to linking the various accounts are disclosed in U.S. patent application Ser. No. 11/779,734, entitled Loyalty Incentive Program Using Transaction Cards, which is herein incorporated by reference in its entirety for any purpose. Similarly, transaction account 104 may be associated with fitness device 106 by registering fitness device 106 with transaction account 104. Registration may include transmitting a device ID to financial institution servers 102 for storage in a database with the device ID associated with a transaction account number. Fitness device 106 may function as a digital wallet to enable transactions through fitness device 106. Functionality may include making payments wirelessly at a point-of-sale, for example. Fitness device 106 may also be in communication through a synching application (e.g., running on a phone, website, computer, or tablet and configured to track fitness activity) connected to a network and in communication with financial institution servers 102. The synching application may track the history of fitness device 108 and communicate with financial institution servers 102 to report fitness activity.

Referring now to FIG. 2, an exemplary process 200 is shown for distributing health-based offers based on location using system 100, in accordance with various embodiments. Process 200 may begin by registering healthy lifestyle locations with financial institution servers 102 (Step 202). Healthy lifestyle locations may include health-related activity locations that may include health-related merchant device 108. Healthy lifestyle locations may include health-related merchants having a health-related merchant device 108. Healthy lifestyle locations may be registered by defining geographic areas on a map that coincide with the locations and storing the geographic areas in a database or filesystem for retrieval. Healthy lifestyle locations may also be registered by obtaining data from existing location systems such as GoogleMaps or MapQuest.

Healthy lifestyle locations may also be registered by associating a health-related merchant device 108 (e.g., BLE beacon or other BLE device) with the healthy lifestyle location in a database. For example, a MAC address or UUID of the health-related merchant device may be stored in a database and indexed using an associated merchant number. The BLE device may broadcast or detect a BLE signal to/from fitness device 106. Offers may also be associated with the registered healthy lifestyle locations and accessible in the database of registered locations. A health-related merchant may submit offers to financial institution servers 102 with the healthy lifestyle locations so the offers may be accessed in the database based on the healthy-lifestyle location. Thus, the offers associated with a location may be provided in response to detecting a fitness device 106 of a user at the location. Offers may be setup with a particular category, for example, all healthy related offers will be stored in a database with a particular category code. To receive the offers, the user may register the transaction account 104 with the type of device. If the registered device is detected in a location then financial institution 102 will push the offers to the device thin BLE or other wireless technology.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Users may also register fitness devices 106 with financial institution servers 102 in association with their transaction accounts 104 (Step 204). Fitness devices 106 may be registered via a web application or native application on a paired computing device. A device identifier such as a universally unique identifier (UUID), major number, and minor number, device ID, MAC address, or other device identifier to identify fitness device 106 may be transmitted to financial institution servers 102 for association with a transaction account 104. The device identifier may be stored in a database table in association with an account number by transaction account server 102 so that the device is associated with a transaction account.

In various embodiments, financial institution servers 102 may detect fitness device 106 at one of the registered healthy lifestyle locations (Step 206). For example, the GPS location of fitness device 106 may be compared to the geographic areas of registered healthy lifestyle locations stored in the database. In another example, a Bluetooth® connection may be established between fitness device 106 and a health-related merchant device 108 located at a registered healthy lifestyle location. The device ID and geographic location may be transmitted to financial institution servers 102, by health-related merchant device 108 and/or fitness device 108, in response to detection and/or establishing a connection. In response to the connection, fitness device 106 and/or health-related merchant device 108 may transmit a notification to financial institution server 102 that fitness device 106 having the device ID registered with a transaction account is present at a healthy lifestyle location.

In various embodiments, financial institution server 102 may identify an offer for user devices detected at healthy lifestyle locations (Step 208). Financial institution servers 102 may use the device ID to look up an associated transaction account in a database and/or communicate with fitness device 108. Financial institution servers 102 may also use the health-related location, as represented by a geolocation or merchant device ID, and look up offers available for that location. The financial institution server 102 may identify the offer by querying a database for offers associated with the registered merchant location. The offer may be stored in the database with other parameters, such as target user preferences, target user characteristics and target fitness devices as provided along with the health-related merchant location. Financial institution servers 102 may transmit the identified offer to fitness device 106 in response to detecting fitness device 106 at the healthy lifestyle location.

With reference to FIG. 3, an exemplary process 300 is shown for issuing rewards points to a transaction account 104 in response to detecting health-related activity using system 100, in accordance with various embodiments. Users may register fitness devices 106 with financial institution servers 102 in association with their transaction accounts 104 (Step 302), as described above. Users may also register social media accounts with financial institution servers 102 in association with a transaction account 104 by providing social media account identification and/or login credentials.

In various embodiments, financial institution servers 102 may detect health-related activity including measurements from fitness device 106, social media posts, and/or user recommendations (Step 304). Health-related activity may be detected by way of receiving a transmission from fitness device 106 associated with transaction account 104 or a program running on a computing device and configured to interact with fitness device 106 (e.g., a syncing application). Health-related activity may also be detected by monitoring a user activity of a group of friends associated over social media in connection with the owner of transaction account 104. Financial institution servers 102 may reward a transaction account holder from the group of friends with points for winning a challenge among the group of friends. For example, a user may create a challenge in the health device to hit 500,000 steps in one week with 10 friends. Whoever wins the challenge gets 500 points as a reward. The 500 points may be deducted from the transaction accounts of the individual card members, who participated in the challenge.

In various embodiments, financial institution servers 102 may issue rewards points to transaction account 104 in response to detecting health-related activity associated with transaction account 104 (Step 306). The rewards points may be redeemable at health-related locations. The rewards points may also be tradeable between transaction accounts of different account holders, between registered users to motivate friends and family towards health-related goals. The rewards points may also be spent or converted in a manner similar to other rewards programs. The points may be unrestricted or restricted for use with health related rewards, in similar geographical areas as where the points were earned, with similar merchants where the points where earned and/or the like. Financial institution servers 102 may transmit a notification to fitness device 106 in response to issuing the rewards points to transaction account 104 (Step 308) The notification may be a push notification, SMS message, email, dashboard interface, or other electronic notification.

With reference to FIG. 4, an exemplary process 400 is shown for issuing rewards points in response to health-related purchases in system 100, in accordance with various embodiments. Process 400 may include registering health-related locations with financial institution servers 102 (Step 402), as described above. Registration may include storing a MAC address, IP address, device ID, UUID, or other identifier associated with a health-related merchant device 108 located at a health-related location. The health-related merchant device may be, for example, a point of sale, tablet, computer, smartphone, or other electronic computing device operated by a health-related merchant at the health-related location.

In various embodiments, users may register fitness devices 106 with financial institution servers 102 in association with their transaction accounts 104 (Step 404), as described above. Fitness device 106 may include a digital wallet and be useable as a medium for completing purchase transactions.

A “digital wallet” may include a software and/or electronic device that facilitates individual e-commerce and m-commerce transactions. The digital wallet may operate by aggregating the transaction account holder's payment and billing information and serving as the merchant of record, and/or passing through the transaction account holder's payment and billing information to the end merchant. Examples of digital wallets currently available may include Apple Pay®, Passbook®, and Google Wallet™.

Financial institution servers 102 may detect a health-related purchase made at a registered health-related location using fitness device 106 and/or transaction account 104 (Step 406). Financial institution servers 102 may detect the health-related purchase by receiving a transaction authorization request from health-related merchant device 108. Financial institution servers 102 may also detect the health-related purchase by a notification transmitted from fitness device 106. Financial institution servers 102 may further detect the health-related purchase by monitoring transaction account 104 for transactions made with registered or otherwise known health-related merchants.

In various embodiments, financial institution server 106 may issue rewards points to the transaction account 104 used in making the health-related purchase in response to detecting the health-related purchase (Step 408). The rewards points may be redeemable at health-related locations. The rewards points may also be tradeable between registered users to motivate friends and family towards health-related goals. The rewards points may also be spent or converted in a manner similar to other rewards programs

In various embodiments, financial institution servers 102 may transmit a notification to fitness device 106 in response to issuing the rewards points to transaction account 104 (Step 410) The notification may be a push notification, SMS message, email, dashboard interface, or other electronic notification.

Referring now to FIG, 5, an exemplary process 500 is shown for issuing rewards points in response to health-related enrollment and/or health-related activity on system 100, in accordance with various embodiments. Process 500 may include registering health-related engagements with financial institution servers 102 (Step 502). Registered health-related engagements may include enrollment and/or attendance related to gym memberships, fitness classes, athletic teams, or other health-related engagements. Registered health-related engagement may also include locations and health-related merchant devices, as described above. The merchant offering the health-related engagements may thus register a health-related merchant device 108 with financial institution servers 102.

In various embodiments, financial institution servers 106 may detect health-related enrollment and activities associated with transaction account 104 (Step 504). Financial institution servers 102 may automatically detect and register health-related engagements by reviewing user transaction histories to identify known health-related merchants. Financial institution servers 102 may also detect health-related activities by detecting the location of fitness device 106 at a health-related location signaling attendance, as described above.

In various embodiments, financial institution server 106 may issue rewards points to the transaction account 104 associated with the health-related engagement in response to detecting the health-related engagement (Step 506). The rewards points may be redeemable at health-related locations. The rewards points may also be tradeable between registered users to motivate friends and family towards health-related goals. The rewards points may also be spent or converted in a manner similar to other rewards programs

In various embodiments, financial institution servers 102 may transmit a notification to fitness device 106 in response to issuing the rewards points to transaction account 104 (Step 508) The notification may be a push notification, SMS message, email, dashboard interface, or other electronic notification.

In various embodiments, the system and method may include alerting a subscriber when their computer is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boat sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

The computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

The computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server such as a digital wallet hub. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.192.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts, See, e.g., Alex Nghiem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly Associates (1998); (3) “Cryptography & Network Security: Principles & Practice” by William Stallings, published by Prentice Hall; all of which are hereby incorporated by reference.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

Phrases and terms similar to “transaction account” may include any account that may be used to facilitate a financial transaction. Phrases and terms similar to “financial institution” or “account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
registering, by a financial institution server, a fitness device with a transaction account by associating a device identifier of the fitness device with the transaction account in a database record;
detecting, by the financial institution server, a health-related activity including at least one of a measurement from the fitness device, a social media post, or a user recommendation; and
issuing, by the financial institution server, a first reward in response to detecting the health-related activity.

2. The method of claim 1, further comprising registering, by the financial institution server, a health-related location by storing a geographic area or a health-related merchant device identifier in a database.

3. The method of claim 2, further comprising:
detecting, by the financial institution server, the fitness device at the health-related location; and
issuing, by the financial institution server, a second reward in response to detecting the fitness device at the health-related location.

4. The method of claim 2, further comprising storing, by the financial institution server, an offer in association with the geographic area or the health-related merchant device identifier.

5. The method of claim 4, further comprising:
detecting, by the financial institution server, the fitness device at the health-related location;
identifying, by the financial institution server, the offer associated with the health-related location; and
transmitting, by the financial institution server, the offer to the fitness device in response to detecting the fitness device at the health-related location.

6. The method of claim 1, further comprising:
detecting, by the financial institution server, a health-related purchase; and
issuing, by the financial institution server, a second reward in response to detecting the health-related purchase.

7. The method of claim 1, further comprising:
detecting, by the financial institution server, a health-related engagement; and
issuing, by the financial institution server, a second reward in response to detecting the health-related engagement.

8. A computer-based system, comprising:
a processor;
a tangible, non-transitory memory configured to communicate with the processor, the tangible, non-transitory memory having instructions stored thereon that, in response to execution by the processor, cause the processor to perform operations comprising:
registering, by the processor, a fitness device with a transaction account by associating a device identifier of the fitness device with the transaction account in a database record;
detecting, by the processor, a health-related activity including at least one of a measurement from the fitness device, a social media post, or a user recommendation; and
issuing, by the processor, a first reward in response to detecting the health-related activity.

9. The computer-based system of claim 8, further comprising registering, by the processor, a health-related location by storing a geographic area or a health-related merchant device identifier in a database.

10. The computer-based system of claim 9, further comprising:
detecting, by the processor, the fitness device at the health-related location; and
issuing, by the processor, a second reward in response to detecting the fitness device at the health-related location.

11. The computer-based system of claim 9, further comprising storing, by the processor, an offer in association with the geographic area or the health-related merchant device identifier.

12. The computer-based system of claim 11, further comprising:
detecting, by the processor, the fitness device at the health-related location;
identifying, by the processor, the offer associated with the health-related location; and
transmitting, by the processor, the offer to the fitness device in response to detecting the fitness device at the health-related location.

13. The computer-based system of claim 8, further comprising:
detecting, by the processor, a health-related purchase; and
issuing, by the processor, a second reward in response to detecting the health-related purchase.

14. The computer-based system of claim 8, further comprising:
detecting, by the processor, a health-related engagement; and
issuing, by the processor, a second reward in response to detecting the health-related engagement.

15. An article of manufacture including a non-transitory, tangible computer readable storage medium having instructions stored thereon that, in response to execution by a server, cause the server to perform operations comprising:
registering, by the server, a fitness device with a transaction account by associating a device identifier of the fitness device with the transaction account in a database record;
detecting, by the server, a health-related activity including at least one of a measurement from the fitness device, a social media post, or a user recommendation; and
issuing, by the server, a first reward in response to detecting the health-related activity.

16. The article of claim 15, further comprising registering, by the server, a health-related location by storing a geographic area or a health-related merchant device identifier in a database.

17. The article of claim 16, further comprising:
detecting, by the server, the fitness device at the health-related location; and
issuing, by the server, a second reward in response to detecting the fitness device at the health-related location.

18. The article of claim 16, further comprising storing, by the server, an offer in association with the geographic area or the health-related merchant device identifier.

19. The article of claim 18, further comprising:
detecting, by the server, the fitness device at the health-related location;
identifying, by the server, the offer associated with the health-related location; and
transmitting, by the server, the offer to the fitness device in response to detecting the fitness device at the health-related location.

20. The article of claim 15, further comprising:
detecting, by the server, a health-related purchase; and
issuing, by the server, a second reward in response to detecting the health-related purchase.
